(19) United States
(12) Patent Application Publication
(10) Pub. No.: US 2006/0041494 A1
(43) Pub. Date: Feb. 23, 2006

(54) Electronic statement preparation

(76) Inventors: Paul Tinnirello, Oldwick, NJ (US); Arthur Snyder III, Oldwick, NJ (US)

Correspondence Address: MORRISON & FOERSTER LLP, 1650 TYSONS BOULEVARD, SUITE 300, MCLEAN, VA, 22102, US

(21) Appl. No.: 11/203,409

(22) Filed: Aug. 15, 2005

Related U.S. Application Data
(60) Provisional application No. 60/601,994, filed on Aug. 17, 2004.

(51) Int. Cl. G06Q 40/00

(52) U.S. Cl. 705/35

(57) ABSTRACT

The invention relates to a system and method for collecting data for use in financial regulatory compliance in the insurance industry. In a preferred embodiment, the invention includes a standardized financial statement for completion by an insurance company. The financial statement provides detail on each insurer's business and investment risks, as well as information on insurance claims and reserves. The financial statement is one of several elements used by regulatory agencies and insurance-industry services providers to assess the financial strength of an insurance company. This assessment provides a reliable, objective means of indicating the financial strength and performance of insurance companies.

### FIELD OF THE INVENTION

The invention relates to a software system for preparing, analyzing, and submitting financial data by insurance companies, although it may be equally applicable to any system in which regulatory data is collected. The system, in an illustrative embodiment, determines whether the data is prepared in accordance with the requirements of the National Association of Insurance Commissioners (NAIC), state insurance regulatory agencies, and/or an independent insurance-industry services provider, such as the A.M. Best Company. The invention performs numerous compliance and consistency checks to ensure that required input maintains data integrity, and submits the data through electronic means to meet the insurance company's regulatory filing criteria for the purposes of financial analysis and for use within the business processes of the insurance-industry services provider.

### BACKGROUND OF THE INVENTION

Each year, most insurance companies writing business in the United States, whether or not based in the United States, are required by the National Association of Insurance Commissioners (NAIC) to complete standardized quarterly and annual statements of their financial condition. The NAIC publishes detailed and extensive regulations for the completion and filing of these statements electronically.

Independent insurance-industry services providers, such as the A.M. Best Company (AMB), develop statement filing software each year in accordance with the NAIC conventions and under agreement with the NAIC. This software is used by the insurance industry to complete financial data, ensure its consistency within NAIC specifications, print copies of the statement in a variety of methods, and submit the financial information to the NAIC, the A.M. Best Company, state insurance regulatory agencies, and other insurance-industry services providers.

For purposes of the present disclosure, the use of statement filing software will be described by way of example, using the A.M. Best Company's procedures. Those skilled in the art will readily recognize that the disclosed software system can be adapted for use by most any independent insurance-industry services provider or software provider.

The present invention, equivalently referenced as “BestESP®”, “ESP”, or “ESP application”, is software used in the statement filing process that conforms to NAIC and AMB conventions.

The NAIC conventions that must be embodied in the software include:
NAIC statement forms which are organized into pages, exhibits, schedules, and supplements and reflect the insurance company's financial condition
Type and format attributes of information to be reported on the forms, including numeric, percentage, factor, textual, date, graphical, precision, length, FEIN, CUSIP, and other attributes
Validation formulas that test the mathematical and logical interrelationship of amounts and text both within and among forms
Narrative explanations that clarify acceptable failures after validation testing
Specifications to convert the information reported on the forms into an electronic filing format
Printed output of the completed statement in Portable Document Format (PDF) or other electronic image format, or a hard copy version
Assembly of the component information into a Zip file format or other single electronically secured file format that may include compression and/or encryption
Submission of the Zip file or other single electronically secured file to the NAIC via the Internet, on diskette or CD/DVD-ROM, or by other electronic means

The major goals of the NAIC electronic filing conventions are increasing the quality of data that is submitted using the statement filing software and achieving complete and timely submission of the data by each insurance company.

### SUMMARY OF THE INVENTION

In an illustrative embodiment, the invention relates to a method for collecting data and, in a preferred embodiment, insurance industry-related data or insurance-industry financial data. A software-based financial statement permits data entry at a user terminal. The software may be installed at the user terminal or present on a host server. Alternatively, components of the software may be present in various locations and initialized or loaded as necessary.

The invention facilitates the entry of data, such as insurance industry-related data and/or insurance-industry financial data. For example, a first datum may be entered in response to a first query and a second datum may be entered in response to a second query. The data are then analyzed using type and format attribute checking and formula validation.

To determine whether each datum is in compliance with electronic filing specification criteria, type and format attribute checking may occur. In order to check each datum individually, the invention should determine whether the datum conforms to certain electronic filing specifications. If the datum conforms to such specifications, as described in step 420 of the FIG. 1, then the datum is deemed “compliant”.

To determine whether the data entered by the user are reasonable, validation may occur. In order to validate the first and second datum, the invention should determine whether the data conform to certain rules. If the data conform to such rules, as described in step 420 of the FIG. 1, then the data are deemed “accurate”.

Compliance and accuracy should not be construed to mean the data entered by the user are correct or reflect true financial information, merely that the information requested by the software is consistent and within the parameters expected for such data. Only the user can determine whether the data being entered are, in fact, correct or reflect true financial information. The present software system, however, determines whether the first and second datum are in compliance by determining whether each datum conforms to an electronic filing specification, and further determines whether the first and second datum are accurate by determining if they have a relationship that conforms to a prescribed formula.

If the data are not in compliance, the invention may require the user to revise such data before continuing. The user may receive management reports or other notices indicating what data are not in accordance with the electronic filing specifications. Missing data or data of an incorrect type or format could be deemed not to be in compliance by the present system. The user must determine how the data can be modified for compliance.

If the data are not accurate, the invention may access a failure explanation file. The user may receive management reports or other notices indicating what data are not in accordance with the validation rules. Data that do not conform to the relationship prescribed by a validation formula could be deemed to be inaccurate by the present system. The user must determine which data can be modified for accuracy, and which inaccurate data require further clarification using the failure explanation file. In a preferred embodiment of the invention, a failure explanation file is created during the data validation process. In the event that entered data are not deemed accurate, an entry is added to the failure explanation file. If all of the data is determined to conform to the software program's guidelines, i.e., the data is accurate, the failure explanation file may be empty.

Once validation is complete and any failure messages have been rectified or explained, the data are assembled for submission. At least the first and second datum are assembled into component files. A single electronically secured file comprising the component files may also be created and then transferred to an insurance-industry regulatory agency or an independent insurance-industry provider of host services.

The present method for collecting data may require establishing communication between a provider of host services and a user computer via network connection, such as the Internet or other distributed network. Once connected, the host services provider may access a data file that includes information previously received from the user computer by the provider of host services. In the situation where the software is installed locally at the user computer, the host may determine whether the user computer has a most recent version of the program installed. If not, the host may execute a software program to update or install software on the user computer configured to collect data.

### BRIEF DESCRIPTION OF THE DRAWING FIGURES

FIG. 1 shows an illustrative flowchart of the software process of the present invention.

### DETAILED DESCRIPTION OF THE INVENTION

Overview of the Statement Completion and Submission Process

Both insurance companies and statement filing software providers are responsible for ensuring that the financial data is reported in the manner prescribed by the NAIC Electronic Filing Submission Directive, which provides general guidelines and specific instructions for compatibility with the electronic filing requirements. With this document as a framework, the major steps in the statement completion and submission process may be summarized as follows:
Insurance companies purchase statement filing software from AMB and run a setup on a workstation, network server, Web services server, or AMB host server.
Company personnel assemble their financial information from a plurality of sources, including but not limited to, internal records, prior year AMB statement filing software, AMB corporate database servers, third-party software, and external parties, and in a plurality of formats, including but not limited to, paper, data files, graphics, word-processing documents, electronic spreadsheets, and PDF files or other electronic image files.
The financial information is incorporated by means of the statement filing software using a plurality of methods, including but not limited to, data entry onto forms, importing data files, word-processing documents, or electronic spreadsheets, electronic scanning of paper documents, and copying externally created PDF files or other electronic image files.
Create a PDF file or other electronic image file, or a hard copy, of audit control management reports for each step of the statement completion and submission process. Those skilled in the art will readily recognize that the “PDF” file format is a standard electronic image scheme used by personal computers running various operating systems.
Check the type and format attributes of each data element for compliance with electronic filing specification criteria.
Revise noncompliant data as reported by type and format checking and run type and format checking repetitively until all failed results have been eliminated.
Run validation formulas to test and report the reasonableness of the data both within and among forms.
Revise invalid data as determined by validations that report failed results and run validations repetitively until all failed results have been eliminated or all acceptable failed results have been identified.
Explain each acceptable failed validation result electronically in narrative form.
Record the statement data in a file format defined by an electronic filing specification.
Create a set of PDF files or other electronic image files of the completed statement that conforms to an electronic filing specification.
Report the failed validation results and their failure explanations in file formats defined by an electronic filing specification.
Assemble the electronic filing component files, including the statement data file, statement PDF files or other electronic image files, validation results file, and validation failure explanation file, into a Zip file or other single electronically secured file that may include compression and/or encryption. Those skilled in the art will readily recognize that the “zip” file format is a standard compression scheme used by personal computers running various operating systems.
Submit the Zip file or other single electronically secured file to the NAIC and state insurance regulatory agencies, using filing Web sites, on diskette or CD/DVD-ROM, or by other electronic means.
Submit electronically secured statement data files to the A.M. Best Company, using a filing Web site, on diskette or CD/DVD-ROM, or by other electronic means.
Forward a separate copy of the statement PDF files or other electronic image files to a commercial printing services provider to reproduce a hard copy version of the completed statement if required.
Send an individualized hard copy of the completed statement to the NAIC, the A.M. Best Company, state of domicile insurance regulatory agency, and other state insurance regulatory agencies and interested parties as necessary.
   The BestESP® Concept

BestESP® (ESP) is an application that may be integrated with the Regulatory Data Uniform Submission Component (RDUSC), or compatible/equivalent software, which is more fully described in commonly assigned, co-pending U.S application Ser. No. 60/601,635, which is hereby incorporated by reference in its entirety. Alternatively, ESP may operate as a stand-alone application on any system where the RDUSC is not available, or where the user does not wish to deploy ESP as an integrated component of the RDUSC. The ESP setup can be run on a user workstation, network server, Web services server, or AMB host server, and updated periodically and as necessary via the Software Support Center. A Web based setup is the preferable distribution method, but alternatives of CD/DVD-ROM, e-mail, or other electronic means, can be available for those users without Internet capability.

Access to data may include both single user and multi-user methods, employing a data locking scheme that is independent of the inherent data locking mechanisms of a database, operating system, or network protocol. In the single user method, the data may only be available to only one user at a time and is locked in its entirety. Another user may not gain access to any data until the current user exits from the ESP application and releases all of the data locks. This method may be useful, for example, in a company where a limited number of users are authorized to run ESP, or where there is restricted access to the data.

By contrast, in the multi-user method, two or more users on a network may share access to the same data by running multiple copies of the ESP application. A single data element is locked by the first user who requests access to that element, and the element may be accessed by any other user only after the first user relinquishes the lock. All other unlocked data elements are available to any other user in a similar manner. The scope of data elements that may be locked by a user can vary considerably, including, but not limited to, a single data entry cell, an entire form, all forms, and various input and output files. The data locking scheme can ensure data integrity by preventing concurrent modification of a data element by multiple users. This method may be useful, for example, in a company where a workgroup of users shares the responsibility of running ESP, or where there is broad access to the data.

ESP may include data entry forms, processes to import data files from external financial software applications, and procedures to incorporate external electronic and paper documents as data; audit control management reports, data validation and verification, and failure explanation procedures; data conversion with compression, PDF or other electronic image creation, and hard copy printing capabilities; type and format checking of data attributes; assembly of component data files into a Zip file or other single electronically secured file that may include compression and/or encryption, electronic media creation, and submission of the single electronically secured file via the Internet, on diskette or CD/DVD-ROM, or by other electronic means; exporting data for use in external software applications; and availability of AMB host servers to incorporate previously filed data, create insurance-industry analytical executive reports, and access on-line insurance-industry resources.

Insurance companies will utilize this statement filing software to assemble their financial data from a plurality of sources and file formats. ESP will incorporate this data, ensure its consistency within NAIC specifications, and create, assemble, and submit the electronic submission component files required by the NAIC, AMB, state insurance regulatory agencies, and commercial printing services providers or other insurance-industry services providers, in a standard and consistent process.

User interfaces for the various aspects of the submission are desirably kept to a minimum in order to automate the ESP process as fully as possible. A user profile and submission checklist will specify the conditions of each submission to run the processes in the proper sequence and eliminate unnecessary user intervention. These conditions can include, but are not limited to, statement type, filing type, and filing deadline; validation results selection and failure explanation creation; component data files to be submitted; Internet, diskette, CD/DVD-ROM, or other electronic means filing preference; and numerous additional options. Audit control reports may also be generated as a PDF file or other electronic image file, or as a hard copy, to manage each step of the submission process.

Mechanisms will be provided to ensure that all components of the submission have been created and assembled by ESP, and not by any external resources that produce electronic image files and electronically secured files with compression and/or encryption. Indicators will be set at various stages, which can be interrogated by software systems at the NAIC, AMB, state insurance regulatory agencies, and commercial printing services providers and other insurance-industry services providers, verifying that the sole source of the submission is the ESP application. The electronic filing could be rejected if these conditions have not been met.

The ESP Architecture

The ESP architecture employs an innovative model that defines the elements and processes as a set of distributed and decentralized services that are reusable by multiple applications. These services may exist anywhere on the network to maximize utilization of the network's characteristics, their location is transparent and immaterial to the user, and they perform specific, discrete functions. This approach offers distinct advantages for ensuring data integrity and security, including verifying and restricting personnel access, creating backup archives, off-site or hot-site warehousing, and encryption. The user is relieved of much of the ongoing activity of data management, and can instead focus on the core business without the added responsibility of system administration.

Traditional software development physically deploys programs, files, and support components of an application in one place and typically expects the input and output data to be available in that same location. For example, an installer program may copy programs, databases, and support files to a designated root folder with sub-folders on a workstation or local network server, and the software may create new data files or incorporate data from external sources using another sub-folder under the same root folder on the same system. The user is required to understand this folder structure and features of the operating system to backup or restore files, retrieve information from a prior year, copy data files from a source location, or copy data files to a target location.

By contrast, the ESP architecture of decentralized services does not require physical deployment of programs, files, and support components of an application on a user workstation or local network server, but merely access to each service at its current host location. Furthermore, there is no requirement to locate programs, databases, and support files at any particular dedicated host or combination of hosts, only that those facilities be available when required. For example, the ESP setup can enable host services at AMB via the Internet to present data entry screens, incorporate previously filed data, check type and format attributes, run validation formulas, create the various electronic filing component files, transfer electronically secured files to a filing Web site, and perform backup operations, while allowing the user to store the data and component files, electronically secured files, and backup files on a workstation or network server. Alternatively, the user could request the ESP setup to enable selected services on company intranet or extranet servers with access to the Internet, while storing the data and component files, electronically secured files, and backup files on AMB servers. The user does not need to understand any folder or network structure or features of the operating system to backup or restore files, retrieve information from a prior year, copy data files from a source location, or copy data files to a target location.

Maximum flexibility and distribution of services are available when the user is connected to the Internet, taking full advantage of the AMB host services in conjunction with the user facilities. In the absence of an Internet connection, the ESP setup can still enable the services architecture on an extranet, intranet, or peer-to-peer network, although with diminishing capabilities. Finally, running the ESP setup on a stand-alone workstation without Internet access will disable all services and install ESP as a traditional application.

As an illustrative embodiment, the ESP architecture is divided into several broad categories, each containing related types of services, which may include, but are not limited to:
AMB Host—services include, but are not limited to, Setup, Software Support Center, Previously Filed Data, Data Submission Site, Executive Reports, On-line Insurance—Industry Resources
Statement Completion—services include, but are not limited to, External Data, Data Entry, Type and Format Checking, Validation, Failure Explanation, Audit Control Reports
Printing—services include, but are not limited to, Electronic Image Copy, Hard Copy
Filing Component—services include, but are not limited to, Statement Data File, Validation Results File, Failure Explanation File, Electronic Image File, Electronically Secured File
Submission—services include, but are not limited to, Filing Site Transfer, CD/DVD Creation, Diskette Creation
Data Export—services include, but are not limited to, NAIC Export, AMB Export, XML Export, XBRL Export, Electronic Spreadsheet Export
Security—services include, but are not limited to, Compression, Encryption, Authentication, Single User/Multi-User Data Access, Backup/Restore
   Advantages of the ESP Design

The ESP advantages for the insurance industry, including the NAIC, AMB, state insurance regulatory agencies, commercial printing services providers and other insurance-industry services providers, and insurance companies, are the following:
The ESP services approach creates a flexible, scalable architecture that utilizes workstations, network servers, Web services servers, and AMB host servers in a distributed environment and to maximum advantage.
The distributed services relieve the user of much of the ongoing activity of data management, and allow the user to instead focus on the core business without the added responsibility of system administration.
It seeks to minimize the interaction between the user and the submission process by encapsulating all of the functionality in a series of automated steps. The user should be concerned primarily with completing the data and filing it by the deadline with the NAIC, the A.M. Best Company, state insurance regulatory agencies, and commercial printing services providers and other insurance-industry services providers, and not the technical basis of creating an NAIC electronic submission by running discrete processes.
The PDF or other electronic image technology implemented in ESP produces efficiently compressed and organized files. Files that are consistently optimized for Internet viewing are available for analysis and printing more readily, and are less wasteful of communication bandwidth.
For users with Internet capability, timely software updates can be provided via the Software Support Center as an automatic service for a user workstation, network server, Web services server, or AMB host server, eliminating the need to manually install periodic and potentially outdated updates by CD/DVD-ROM, e-mail, or other electronic means. Variations in data submission arising from differing software versions can be minimized.
   Illustrative Overview of the ESP Model

In an illustrative embodiment, the ESP model is divided into several broad areas of functionality, as follows.
100 Series—ESP setup is run on a user workstation, network server, Web services server, or AMB host server, from a plurality of sources.
200 Series—AMB host servers and other facilities at AMB provide services via the Internet.
300 Series—ESP optionally accesses previously filed data as available from AMB, and incorporates AMB and other external data into the statement data from a plurality of file formats.
400 Series—User completes the statement data. ESP analyzes the statement data, provides audit control management reports, creates the electronic submission component files, assembles the submission in a plurality of methods for the NAIC, the A.M. Best Company, state insurance regulatory agencies, and commercial printing services providers and other insurance-industry services providers, and exports the statement data in a plurality of file formats.
500 Series—User manually sends the single secured electronic submission file to the NAIC, state regulatory insurance agencies, and other insurance-industry services providers, if Internet access is not available, and additionally sends a hard copy of the completed statement to these entities and the A.M. Best Company by mail or other delivery service. User manually sends PDF files or other electronic image files of the completed statement separately to a commercial printing services provider, if Internet access is not available.
600 Series—ESP automatically transfers the single secured electronic submission file to the NAIC Web site, and transfers PDF files or other electronic image files of the completed statement to a commercial printing services provider Web site, if the user has Internet access.
700 Series—ESP creates executive reports using the current statement data and previously filed data as available from AMB, and accesses on-line insurance-industry resources at AMB.
800 Series—ESP automatically transfers statement data in a plurality of electronically secured file formats to an AMB Data Submission Site via the Internet, or the user manually sends the secured electronic data files on diskette or CD/DVD-ROM, or by other electronic means, to AMB if Internet access is not available.
900 Series—User imports statement data into a plurality of external software applications.
   Description of the ESP Flowchart

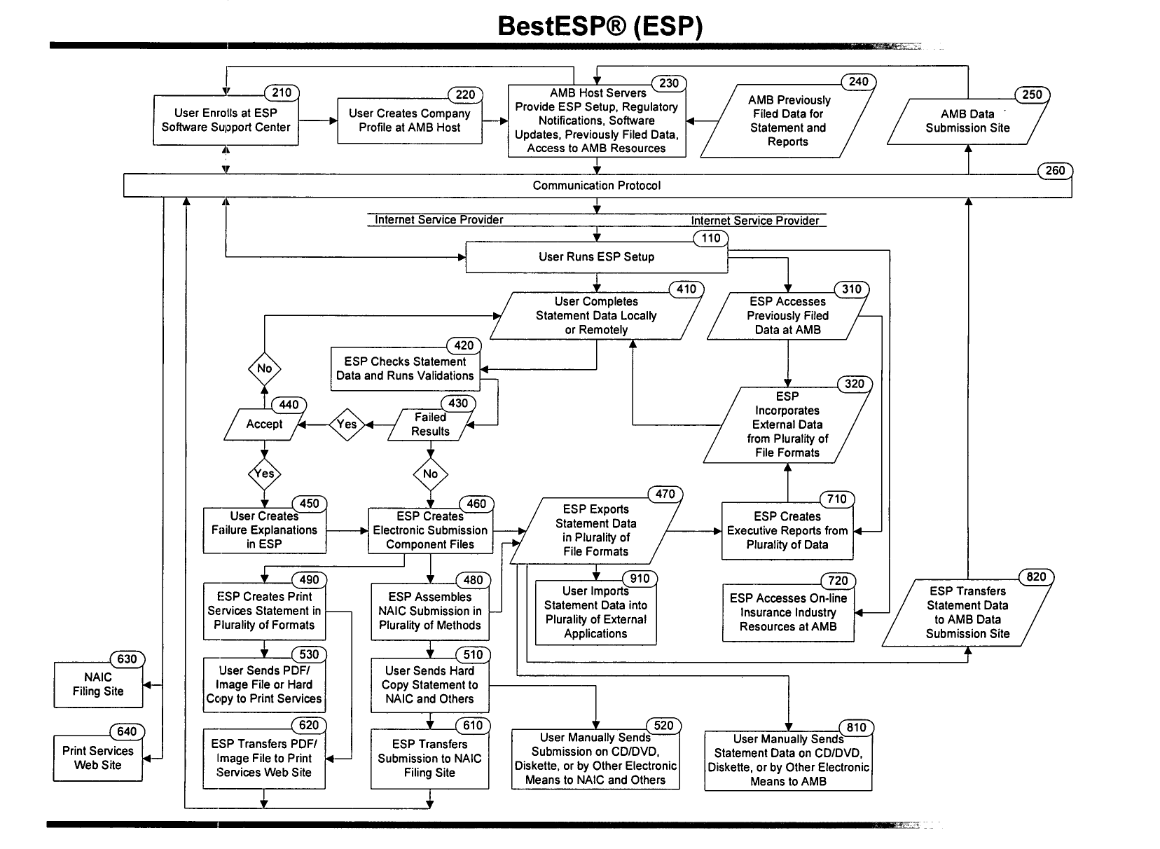

Following is a detailed description of the illustrative model embodied in the ESP flowchart, shown in FIG. 1:
110—The ESP software setup is run by the user, on any combination of workstations, network servers, Web services servers, or AMB host servers. ESP may be run as an integrated component of the RDUSC software, or as a stand-alone application on any system where the RDUSC is not available, or where the user does not wish to deploy ESP as an integrated component of the RDUSC. The preferred setup method will be to run the Web based process from an AMB host server at (230) via Internet browser software that connects to the Software Support Center at (210). After completing the enrollment procedure at (210), the company profile at (220), and the ESP setup at (230), the AMB host services will be available. Ongoing communication between the user and the AMB host services will be provided via the Software Support Center. Alternative CD/DVD-ROM, e-mail, or other electronic setups will be available for users without Internet capability, but these would not provide access to the AMB host services. ESP may be configured to transmit information over an open network such as the Internet, a peer-to-peer local area network such as Microsoft Networking, an intranet, extranet, or other wide area network, a mobile device such as Blackberry, or any combination, using communication protocols that can include, but are not limited to, TCP/IP, FTP, HTTP, and SSL.
210—The user enrolls at the ESP Software Support Center for online software support and other AMB host services. Enrollment involves establishing traditional mailing and electronic contact information, and creating an account number and security profile. The enrollment information will be used to provide ongoing Web based support for ESP and the data submission process. The Software Support Center will be the portal by which ESP communicates between the user and the AMB host services.
220—The user supplements (210) by additionally creating a company profile at an AMB host server. The profile will define a plurality of operating environments for the user, including, but not limited to, workstations, network servers, Web services servers, AMB host servers, communication facilities, types of host services, file locations, and other preferences. The types and frequency of e-mail broadcast notifications and automated software updates the user wishes to receive, and access to previously filed data, executive reports, and AMB on-line insurance-industry resources, will be customized. The profile will also control the transfer of data to an AMB Data Submission Site at (250), the NAIC filing site at (630), and a commercial printing services provider Web site at (640).
230—AMB host servers provide the Web based setup for ESP, periodic regulatory notification by e-mail, automated software updates, previously filed data, analytical executive reporting, access to AMB on-line insurance-industry resources, and transfer acknowledgements for data received at (250). The type and frequency of these communications will be based upon the information provided at (210) and (220).
240—ESP accesses the AMB corporate database servers to provide previously filed data at (310) for statement completion at (410) and the executive reports created at (710). The type of data available to the user is based upon the information provided in the company profile at (220).
250—An AMB Data Submission Site may comprise a plurality of AMB host servers that receive transfers of electronically secured statement data files from ESP at (820), based upon the information provided at (220). Verification and acknowledgement of these transfers are sent to the user at (230).
260—Communication between the user and AMB host services is conducted via the Internet using protocols that can include, but are not limited to, TCP/IP, FTP, HTTP, and SSL. The user must make arrangements with an Internet Service Provider to install the appropriate communication capability, which may include, but is not limited to, dialup, DSL, cable, T1, and WiFi.
310—ESP accesses the AMB corporate database servers at (240) to provide previously filed data for statement completion at (410) and the executive reports created at (710). The type of data available to the user will be based upon the information provided in the company profile at (220).
320—ESP incorporates external data into the statement data from a plurality of file formats. These file formats can include, but are not limited to, previous year ESP statement data files, NAIC electronic submission component data files, AMB data file import specifications, AMB executive report data, PDF files or other electronic image files, electronically scanned paper documents, electronic spreadsheet files, and databases or other data structures incorporating XML, XBRL, or other mark-up or tagging languages. The plurality of external data file formats will be converted to a common file format specified by ESP,
410—The user completes the statement data from a plurality of current year and previously filed sources. These sources can include, but are not limited to, manual entry from company records, external PDF files or other electronic image files, electronic scanning of paper documents, electronic spreadsheets, AMB corporate database servers at (310), and a plurality of external data at (320). The plurality of data files may reside on a user workstation, network server, Web services server, AMB host server, or any combination. Audit control reports may also be generated as a PDF file or other electronic image file, or as a hard copy, to manage each step of the statement completion and submission process. The results that are reported may include, but are not limited to, incorporating external data, checking the type and format of data attributes, running validations, creating and assembling the electronic submission component files, or transferring electronically secured files to the NAIC, AMB, state insurance regulatory agencies, and commercial printing services providers and other insurance-industry services providers.
420—ESP checks the type and format attributes of each statement data element for compliance with NAIC electronic filing specification criteria. The type attributes can include, but are not limited to, numeric, percentage, factor, textual, date, and graphical, while the format attributes may include, but are not limited to, missing data, precision, length, FEIN, and CUSIP. ESP runs the NAIC validation formulas to test and report the reasonableness within validation rules of statement data, and additionally, provides optional AMB validations that extend the scope of this data testing beyond the NAIC standards. AMB validations are included to enhance the ESP analysis capability only, and are not required for compliance with the electronic submission as prescribed by the NAIC Electronic Filing Submission Directive. A typical validation of statement data may comprise a large number of computations, each requiring the evaluation of many mathematical formulae, in order to ensure that the statement data conforms to expected guidelines. A large statement, for example, may require hundreds of thousands of calculations to validate. Validation formula characteristics may include, but are not limited to, single and multiple mathematical and logical operators within each formula, individual or combination testing of inter-form and intra-form data, single or multiple testing steps within each formula, and dollar or percentage tolerances that define an allowable deviation from a target amount. Whenever electronic filing specification or validation formula revisions or enhancements for the current year are required, they may be accessed via the Software Support Center at (210) if the user is connected to the Internet, while users without Internet capability will receive a CD/DVD-ROM, e-mail, or other electronic update at appropriate intervals.
430—ESP reports the results of checking the type and format attributes, and running the NAIC validations, and indicates whether any results have failed. ESP reports the results of running the optional AMB validations and indicates whether any results do not meet AMB guidelines. Failed attribute checking results or failed NAIC validation results will require additional analysis by the user at (440), while an absence of failed results will allow the user to create the electronic submission component files at (460). AMB validation results that do not meet AMB guidelines may be analyzed optionally at (440), but these validation results will not preclude creating the electronic submission component files at (460).
440—The user must analyze each failed attribute checking result and each failed NAIC validation result for its validity, and optionally analyze each AMB validation result that does not meet AMB guidelines. The majority of failed NAIC results will be unacceptable, due primarily to improper or inconsistent statement data, which must be revised at (410). An individual data element is not permitted to deviate from the type and format attributes for that element and must always be revised for compliance with the electronic filing specification criteria. However, validation results may justifiably fail due to business exceptions, or because the validation formula needs revision. In these acceptable instances, the user may override the failure by creating an explanation at (450) for each failed NAIC validation result. AMB validation results that do not meet AMB guidelines, but which are acceptable, neither require nor permit an explanation at (450).
450—ESP provides the ability for the user to create an electronic narrative explanation for any failed NAIC validation result that is identified as acceptable. The user can not create the electronic submission component files at (460) until all failed NAIC validation results have been explained in this manner. The user will perform (410) through (450) repetitively until all unacceptable failed NAIC validation results have been revised and all acceptable failed NAIC validation results have been explained. The user may optionally perform (410) through (440) repetitively until all AMB validation results that do not meet AMB guidelines, and which are unacceptable, have been revised, but an explanation for these AMB validation results is neither required nor permitted at (450).
460—ESP creates the component files required by the NAIC electronic submission conventions. The statement data will be recorded in a Statement Data Submission File and the completed statement will be printed in a set of Statement Data PDF Files. The failed NAIC validation results and their explanations will be reported in a Validation Results Submission File and Validation Failure Explanation Submission File, respectively.
470—ESP exports the completed statement data in a plurality of file formats with compression and/or encryption for use with executive reports at (710), copying the files to diskette or CD/DVD-ROM, or other electronic means, to send to AMB at (810), Internet transfer to an AMB Data Submission Site at (820), and import into a plurality of external applications at (910). These file formats can include, but are not limited to, Zip file or single electronically secured file, AMB data file export specifications, PDF files or other electronic image files, electronic spreadsheet files, and databases or other data structures incorporating XML, XBRL, or other mark-up or tagging languages. Various compression algorithms may be used for efficiency with different file types, and can include, but are not limited to, Zip for data, JPEG or GIF for images, PDF for documents, and MPEG or WAV for streaming media. Encryption may be accomplished using commercially available 128-bit or higher software, and additional security and authentication can include, but is not limited to, VeriSign, Thawte, or similar management services.
480—ESP assembles the component files into a Zip file or other single electronically secured file with compression and/or encryption in a plurality of methods for submission to the NAIC, AMB, state insurance regulatory agencies, and other insurance-industry services providers. These methods can include, but are not limited to, storing the file on a user workstation, network server, Web services server, or AMB host server, for eventual Internet transfer to the NAIC filing site at (630) or an AMB Data Submission Site at (820), and copying the file to diskette or CD/DVD-ROM, or other electronic means, to send to the NAIC, state insurance regulatory agencies, or other insurance-industry services providers at (520) or AMB at (810). ESP also prints a hard copy of the completed statement be sent to the NAIC, AMB, state insurance regulatory agencies, or other insurance-industry services providers at (510).
490—ESP creates a separate copy of the completed statement in a plurality of formats to be provided to a commercial printing services provider. These formats can include, but are not limited to, storing a PDF file or other electronic image file on a user workstation, network server, Web services server, or AMB host server, for eventual Internet transfer to a commercial printing services provider Web site at (640), and copying the PDF file or other electronic image file to diskette or CD/DVD-ROM, or other electronic means, or printing a hard copy, to send to a commercial printing services provider at (530).
510—The user sends a hard copy of the completed statement to the NAIC, AMB, state insurance regulatory agencies, or other insurance-industry services providers by mail or other delivery service.
520—The user sends the Zip file or other single electronically secured file on diskette or CD/DVD-ROM, or by other electronic means, to the NAIC, state insurance regulatory agencies, or other insurance-industry services providers, by mail or other delivery service. Sending the Zip file or other single electronically secured file by these methods supersedes transferring the file to the NAIC filing site at (630).
530—The user sends the completed statement as a PDF file or other electronic image file, on diskette or CD/DVD-ROM, or by other electronic means, or as a hard copy, to a commercial printing services provider by mail or other delivery service. Sending the completed statement by these methods supersedes transferring the statement to a commercial printing services provider Web site at (640).
610—ESP connects to the NAIC filing site via the Internet, identifies and locates on a user workstation, network server, Web services server, or AMB host server, the required Zip file or other single electronically secured file to be submitted, and transfers the selection. Transferring the Zip file or other single electronically secured file by this method supersedes sending the file on diskette or CD/DVD-ROM, or by other electronic means, at (520).
620—ESP connects to a commercial printing services provider Web site via the Internet, identifies and locates on a user workstation, network server, Web services server, or AMB host server, the required PDF file or other electronic image file to be printed, and transfers the selection. Transferring the PDF file or other electronic image file by this method supersedes sending the file on diskette or CD/DVD-ROM, or by other electronic means, at (530).
630—The NAIC filing site receives the Zip file or other single electronically secured file transferred by ESP. Additional verification and acknowledgement may performed by the NAIC filing site.
640—A commercial printing services provider Web site receives the PDF file or other electronic image file transferred by ESP. Additional verification and acknowledgement may be performed by the commercial printing services provider Web site.
710—ESP creates executive reports from a plurality of data sources that are customized by the company profile at (220), which can include, but are not limited to, current year statement data and previously filed information from AMB corporate database servers. These reports can include, but are not limited to, analysis by peer companies, groups of companies, or industry segments.
720—ESP accesses on-line insurance industry resources at AMB. These resources can include, but are not limited to, daily, weekly, and monthly news publications, statistical studies, and rating methodology. The type of resources available to the user will be based upon the information provided in the company profile at (220).
810—The user sends the electronically secured statement data files on diskette or CD/DVD-ROM, or by other electronic means, to AMB by mail or other delivery service. Sending the electronically secured statement data files by these methods supersedes transferring the files to an AMB Data Submission Site at (820).
820—ESP connects to an AMB Data Submission Site via the Internet, identifies and locates on a user workstation, network server, Web services server, or AMB host server, the required electronically secured statement data files to be submitted, and transfers the selections. Transferring the electronically secured statement data files by this method supersedes sending the files on diskette or CD/DVD-ROM, or by other electronic means, at (810).
910—User imports statement data into a plurality of external applications. These applications can include, but are not limited to, general ledger systems, electronic spreadsheets, tax preparation systems, and corporate databases.

The present disclosure relates to a preferred embodiment of the present invention and is applicable to a wide variety of uses within the insurance industry. For example, although insurance-industry financial data is used throughout the description, the invention may include the use of insurance-related data generally and not merely be limited to the embodiments described herein.

What is claimed:

1. A method for collecting data, comprising:
initializing a software-based insurance industry-related financial statement;
entering a first insurance industry-related datum in response to a first query;
entering a second insurance industry-related datum in response to a second query;
checking the type and format attributes of each datum;
determining whether each insurance industry-related datum is in compliance, wherein the compliance of each datum is determined by whether it conforms to electronic filing specification criteria;
validating the first and second insurance industry-related data;
determining whether the first and second insurance industry-related data are accurate, wherein the accuracy of the first and second insurance industry-related data is determined by whether the first and second insurance industry-related data have a relationship that conforms to a prescribed formula;
creating a failure explanation file and creating an entry in the failure explanation file if the first and second insurance industry-related data are not accurate;
assembling at least the first and second insurance industry-related data into component files;
creating an electronically secure data file comprising the component files;
transferring the data file to the originator of the financial statement.

2. The method of claim 1 wherein the software-based insurance industry-related financial statement is configured to be accessed via a user terminal.

3. The method of claim 2 wherein the user terminal communicates with a provider of host services via a distributed network.

4. The method of claim 3 comprising downloading software components to the user terminal from the provider of host services.

5. The method of claim 4 comprising enrolling a user on the provider of host services and providing software support to the user, the software support comprising product updates, product news, customized user-specific information, and combinations thereof.

6. The method of claim 1 wherein the secure data file is encrypted and/or compressed.

7. The method of claim 1 wherein the secure data file is transferred to the originator of the financial statement via a network connection.

8. The method of claim 5 comprising automatically transmitting product updates to the user terminal.

9. The method of claim 1 wherein the originator of the financial statement comprises at least one server for receiving at least one secure data file from at least one user terminal.

10. The method of claim 9 comprising transmitting a verification and/or acknowledgement from the originator to the user terminal when a secure data file is received by the originator.

11. The method of claim 1 wherein the insurance industry-related data comprises insurance data, financial data, data that is requested in response to a requirement of law or industry regulation, or combinations thereof.

12. A method for collecting insurance industry-related data, comprising:
establishing communication between a provider of host services and a user terminal via network connection;
accessing a data file including information previously received from the user terminal by the provider of host services;
determining whether the user terminal has a most recent version of a software program installed;
optionally executing a software program to update or install software on the user terminal configured to collect insurance industry-related data;
collecting more than one insurance industry-related datum;
determining whether each insurance industry-related datum entered into the software program is in compliance by checking the type and format attributes of each datum, wherein an insurance industry-related datum is considered to be in compliance when it conforms to electronic filing specification criteria;
determining whether the insurance industry-related data entered into the software program is accurate by validating at least one datum with at least one other datum, wherein insurance industry-related datum are considered to be accurate when they conform to a prescribed relationship;
creating a failure explanation file and creating an entry in the failure explanation file if the insurance industry-related data is not accurate, the entry comprising a failure explanation message;
assembling the insurance industry-related data into component files;
creating a data file comprising the component files; transferring the data file to the originator of the financial statement.

13. The method of claim 12 wherein the data file is encrypted and/or compressed.

14. The method of claim 12 wherein the data file is forwarded to the originator of the financial statement on a CD-ROM, DVD, floppy diskette, hard disk drive, or tape cartridge.

15. The method of claim 12 wherein the data file is printed and forwarded to the originator of the financial statement.

16. The method of claim 12 wherein the data file is transferred to the originator server via the Internet.
